(19) United States
(12) Patent Application Publication
(10) Pub. No.: US 2018/0128922 A1
(43) Pub. Date: May 10, 2018

(54) Multimode LIDAR System for Detecting, Tracking and Engaging Small Unmanned Air Vehicles

(71) Applicant: Irvine Sensors Corporation, Costa Mesa, CA (US)

(72) Inventors: James Justice, Newport Beach, CA (US); Medhat Azzazy, Laguna Niguel, CA (US)

(73) Assignee: Irvine Sensors Corporation, Costa Mesa, CA (US)

(21) Appl. No.: 15/459,655

(22) Filed: Mar. 15, 2017

Related U.S. Application Data
(60) Provisional application No. 62/312,552, filed on Mar. 24, 2016.

(51) Int. Cl. G01S 17/89; G01S 17/66

(52) U.S. Cl. CPC G01S 17/89; G01S 17/66

(57) ABSTRACT

The LIDAR system disclosed herein consists of a wide area search LIDAR subsystem and a narrow field of view 3D Imaging LIDAR subsystem that detects, tracks, and recognizes small Unmanned Aerial Vehicles at ranges that enable interference with the Unmanned Aerial Vehicle mission if desired. The disclosed LIDAR system discriminates the detected small Unmanned Aerial Vehicles from similar, but different, observed objects. The disclosed LIDAR system uses eye safe SWIR lasers for both the search and imaging modes of operation. A signal processor analyses the LIDAR sensor system outputs and provides precision range estimations of observed objects.

### CROSS-REFERENCE TO RELATED APPLICATIONS

This application claims the benefit of U.S. Provisional Patent Application No. 62/312,552, filed on Mar. 24, 2016 entitled “A Multimode LIDAR System for Detecting, Tracking, and Engaging Small Unmanned Air Vehicles” pursuant to 35 USC 119, which application is incorporated fully herein by reference.

### STATEMENT REGARDING FEDERALLY SPONSORED RESEARCH AND DEVELOPMENT

N/A.

### BACKGROUND OF THE INVENTION

### 1. Field of the Invention

The invention relates generally to the field of imaging and tracking LIDARS.

More specifically, the invention relates to a multimodal LIDAR sensor suite that accomplishes wide area surveillance for the detection of Small Unmanned Air Vehicles (SUAS), tracking of the SUAS in a track-while-scan mode, high resolution imaging of the SUAS for target recognition, and illumination of the SUAS to enable SUAS engagement through semi-active homing.

### 2. Description of the Related Art

The successful detection, tracking, recognition, and engagement of Small Unmanned Air Vehicles is a particularly difficult job due to the small size of the SUAS targets and their ability to fly at various altitudes and speeds. Current State of the art systems accomplish the listed functions using disparate sensing techniques and separate sensor system elements. Search and detection is typically accomplished by radars which have difficulty detecting the smaller types of SUAS because of their size and the materials of which they can be made which often do not reflect radar signals and are thus low observable targets. Radars which perform the SUAS detection function are typically large and pose problems when man portability is desired. The radar system solutions can perform target tracking if the target is reliably detected. The radar solution cannot provide sufficient resolution on the tracked targets to reliably identify them. In the state of the art systems, the recognition problem is solved by adding an electro-optical or thermal imaging system that can obtain high resolution images of the tracked SUASs. These recognition adjunct sensors provide only two dimensional images. Visible sensor adjuncts do not operate at under low light conditions or at night. The thermal sensors do operate day/night but do not perform well in conditions of degraded visual environments. Neither the radar detection and tracking sensors nor the visual or thermal target recognition sensors can provide target illumination that enables homing missiles to engage the SUAS in a semi-active homing mode.

What is needed is a compact sensor suite that can perform all the critical detection, tracking, recognition, and engagement functions, operate day and night reliably, operate effectively under conditions of degraded visibility caused by fog, rain, or dust, and be deployable in fixed locations or on mobile platforms. The LIDAR sensor system disclosed herein is such a system.

### BRIEF SUMMARY OF THE INVENTION

The sensor system disclosed herein is a compact apparatus that consists of a set of eye safe LIDARS operating at the 1.5 micron wavelength. One of the LIDARS is designed for optimum search, detection, and track-while-scan operation. The second LIDAR, tasked by the track data from the search LIDAR, performs a highly precise track on the SUAS targets and provides high resolution, three dimension images of the targets that enable reliable target recognition. This three dimensional imaging LIDAR also illuminates the targets with enough pulses that a homing missile can engage the SUAS target in a semi-active homing mode. An additional capability of this illumination mode is achieved if the SUAS is intended to be operating in the area and its engagement is not desired. This additional capability arises if the SUAS has a method of detecting the pulses and pulse pattern of the illuminating LIDAR and can issue a detectable response as a form of Identify Friend or Foe (IFF).

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts the Counter SUAS LIDAR Sensor System Design Concept.

FIG. 2 presents the Counter SUAS LIDAR Sensor System's Exemplar Operations Timeline showing the full integration of all the disclosed functionalities.

FIG. 3 presents the detail design features of the multimodal Counter SUAS LIDAR Sensor System.

FIG. 4 shows the detection performance of the Counter SUAS Search/Track LIDAR element.

FIG. 5 shows the tracking performance of the Track-While-Scan mode of operation.

FIG. 6 shows the Target recognition performance of the High Resolution Imaging LIDAR element and an example of a SWIR Three Dimensional LIDAR High Resolution Image.

FIG. 7 shows the operation of the laser element of the Search/Track System Sensor.

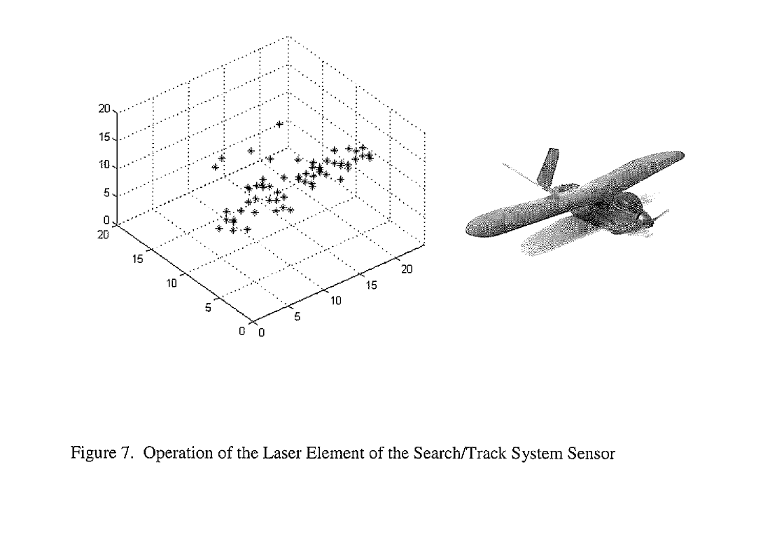

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Two major national problems are arising because of the use of Small Unmanned Air Vehicles. First, potential military adversaries are now employing SUAS in a fashion that pose risks to the effectiveness of US military forces. Second, use of SUAS in the US National Air Space is causing increasing concerns over safety. The Counter SUAS apparatus disclosed herein is responsive to these two problem areas.

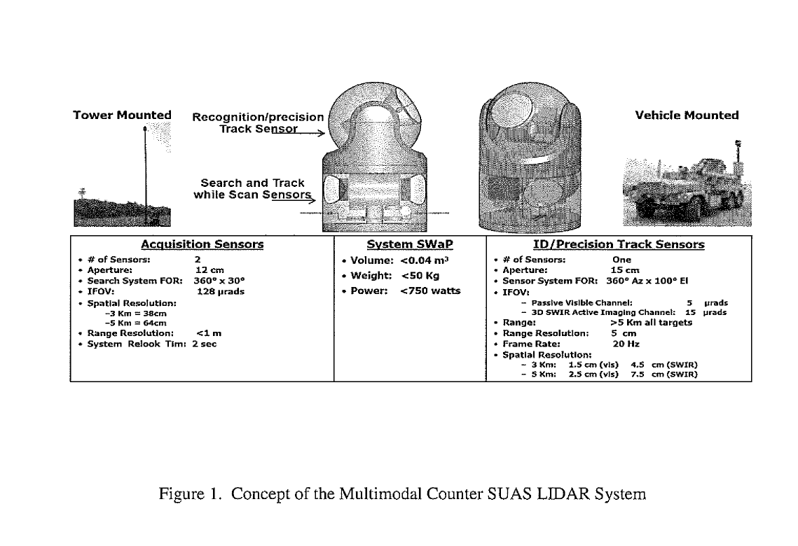

The Counter SUAS sensor suite consists of two types of LIDARs, a) a search and detection LIDAR which executes wide area surveillance and detects SUASs within a large volume and b) a narrow field of view LIDAR which provides precision tracking, target recognition, and illumination supporting semi-active homing engagements. The compact sensor suite can be deployed on fixed towers on mobile platforms as illustrated in FIG. 1.

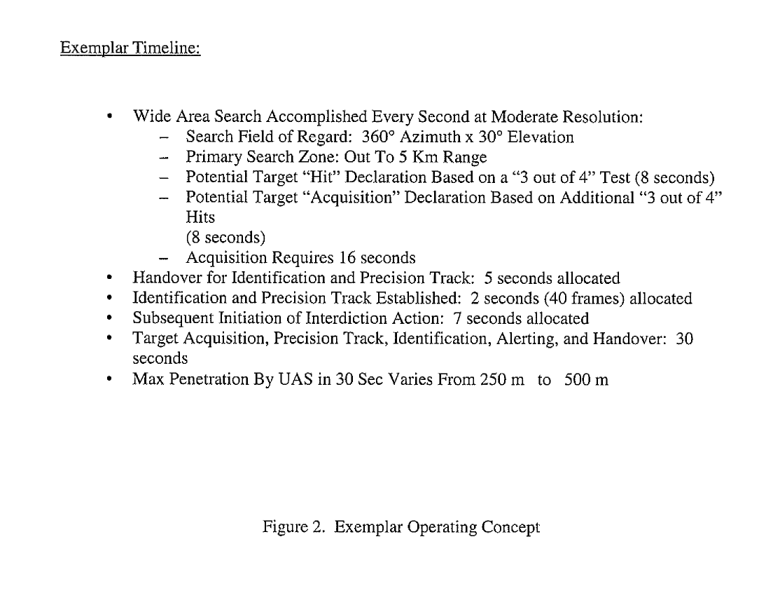

The concept of operations of the disclosed sensor system and an exemplar operations timeline, illustrated in FIG. 2, begins with the a search LIDAR preforming wide area surveillance at extended range, out to 5 km, and over a 30 degree elevation by 360 degree azimuth volume. This volume is searched by the eye safe SWIR LIDAR every 1 to 2 seconds. The fully eye safe operation of the laser element is critical to the sensor suite use in areas where people might be illuminated. Detection of the SUASs with cross section as low as 0.15 sq. meters, occurs at ranges of >5 km. Track association processing over multiple looks establishes a high probability of detection and, with track-while-scan processing, results in highly accurate localization of the SUAS. The search LIDARS operate continuously. Search is effected by a rotating table upon which the search LIDAR elements are mounted. Once a SUAS is detected and its track established, a handover is executed to a narrow field of view, high resolution 3D imaging LIDAR which acquires the target and establishes precision track by illuminating the target at a rate of up to 30 Hz. This Imaging LIDAR is also operating in the fully eye safe SWIR wavelength of 1.5 microns. Each of the LIDAR pulses produces a high resolution three dimensional image of the SUAS and enables confident target recognition. Continued illumination of the SUAS by the imaging LIDAR can also enable a semi-active homing engagement. The imaging LIDAR is mounted in a two Axis gimbal that allows it access to the hemisphere of coverage over the location. Sensitivity of the imaging LIDAR insures that it can image any SUAS acquired by the extended range search LIDAR anywhere within the search volume.

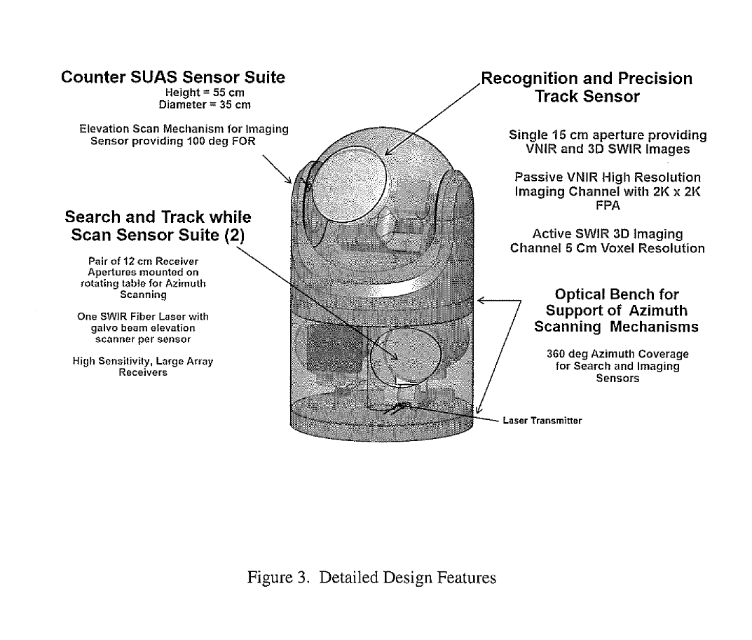

The detailed design elements of the Counter SUAS system are shown in FIG. 3. A large linear focal plane array of SWIR sensitive detectors fills the elevation field of view. These individual detector elements are integrated with a Read Out Integrated Electronic circuit which samples the detectors at very high rates, determines the time of flight of a laser pulse to a target and estimates range to the target. A two dimensional area array of SWIR sensitive detectors fills the Imaging LIDAR field of view. Integrated sampling circuits enable accurate (˜few cm) multiple range measurements as the transmitted pulse travels over the target thus generating the high resolution three dimensional image of the target. Target recognition image processing is based on exploitation of cognitive-inspired techniques that use detailed three dimensional spatial information of target shape and fine scale dynamic behavior of the observed target combined with template matching over a catalog of possible vehicles is used to accomplish recognition.

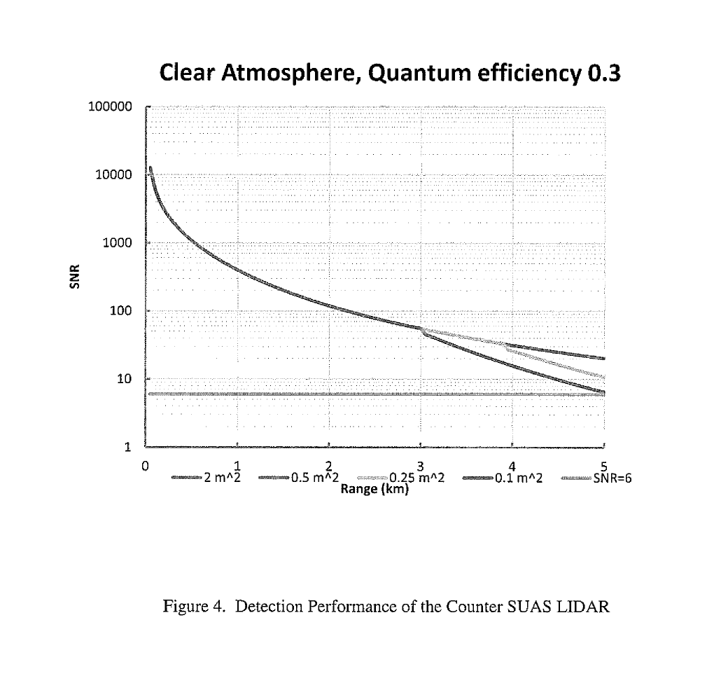

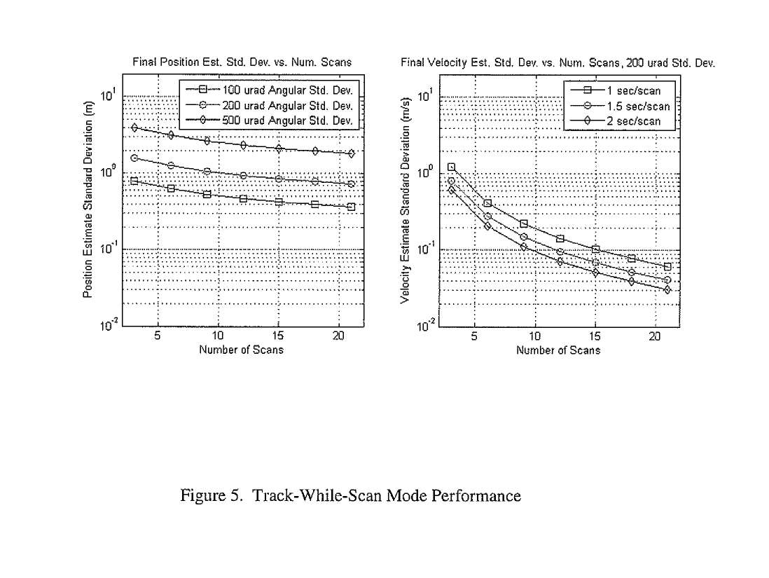

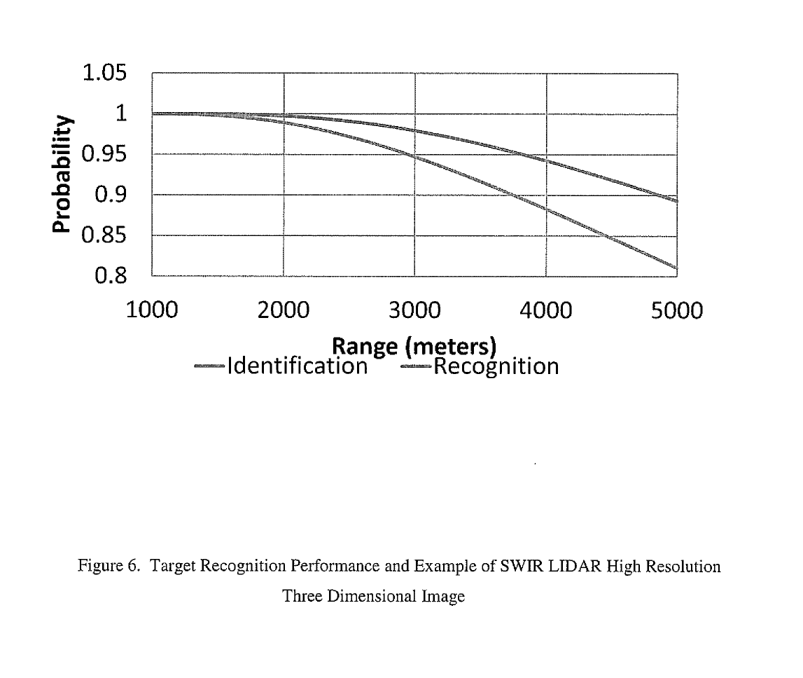

Detection performance of the Search/Track LIDAR is shown in FIG. 4. Tracking performance accuracy of the track-while-scan mode of operation is shown in FIG. 5. Highly accurate localization occurs after only a few observations due to the high inherent resolution of the search LIDAR. This accurate localization insures a reliable handover to the narrow field high resolution Imaging LIDAR. FIG. 6 shows the predicted target recognition capability of the Counter SUAS imaging sensor and presents an example of a SWIR high resolution image of a Very Small UAS taken by a SWIR LIDAR of the class disclosed herein.

The Size, Weight, and Power (SWaP) requirements of the disclosed Counter SUAS sensor suite enable it to be deployed on fixed towers, on mobile vehicles, be portable by a two man team.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A LIDAR apparatus that detects, tracks, recognizes small unmanned aerial vehicles at ranges sufficient to enable interference with the Unmanned Aerial Vehicle's mission.

2. The LIDAR apparatus of claim 1 may contain multiple LIDAR sensors.

3. The LIDAR apparatus of claim 1 may contain a wide area search LIDAR for detection and tracking of small Unmanned Aerial Vehicles which operates in the SWIR spectral band

5. The LIDAR apparatus of claim 1 may contain an imaging LIDAR for precision tracking and recognition of small Unmanned Aerial Vehicles which operates in the SWIR spectral band

6. The LIDAR apparatus of claim 1 may contain a signal processing unit that determines the accurate range to detected objects, Associates multiple object observations into associated tracks, recognizes the small Unmanned Aerial Vehicles and discriminates them from other similar, but not Unmanned Aerial Vehicle objects that may be observed.

7. The LIDAR apparatus of claim 1 may contain a wide field of view optics that transmit and receive in the SWIR spectral band and accomplishes the search function.

8. The LIDAR apparatus of claim 1 may contain a narrow field of view optics that transmit and receive in the SWIR spectral band and accomplishes the target recognition function.

9. The LIDAR apparatus of claim 1 may contain elements that accomplish the required motions of the search and of the imaging subsystems of the apparatus.

10. The LIDAR apparatus of claim 1 man contain a signal processing unit that analyzes the LIDAR system output signals, forms track associations, recognizes small Unmanned Aerial Vehicle targets, and distinguishes them similar, but different, objects that have been observed.
